(19) United States
(12) Patent Application Publication
(10) Pub. No.: US 2026/0302536 A1
(43) Pub. Date: Oct. 1, 2026

(54) METHOD FOR MANUFACTURING BATTERY

(71) Applicant: HONDA MOTOR CO., LTD., Tokyo (JP)

(72) Inventor: Keishi KOSAKA, Saitama (JP)

(73) Assignee: HONDA MOTOR CO., LTD., Tokyo (JP)

(21) Appl. No.: 19/578,922

(22) Filed: Mar. 26, 2026

(30) Foreign Application Priority Data
Mar. 28, 2025 (JP) 2025-056011

(51) Int. Cl. H01M 50/477; H01M 4/134; H01M 10/0585; H01M 4/02

(52) U.S. Cl. CPC H01M 50/477; H01M 4/134; H01M 10/0585; H01M 2004/027

(57) ABSTRACT

A method for manufacturing a battery in which plural cushioning members and plural cells each disposed between adjacent two of the cushioning members are laminated in a laminating direction, includes: compressing a laminate of the plural cells and the plural cushioning members while repeating pressurization and depressurization on the laminate in the laminating direction according to a change in posture of the laminate with respect to the laminating direction.

### CROSS-REFERENCE TO RELATED APPLICATION

This application is based on and claims priority under 35 USC 119 from Japanese Patent Application No. 2025-056011 filed on Mar. 28, 2025.

### TECHNICAL FIELD

The present invention relates to a method for manufacturing a battery.

### BACKGROUND ART

In recent years, researches and developments have been conducted on a secondary battery which contributes to improvement in energy efficiency in order to allow more people to have access to affordable, reliable, sustainable and advanced energy.

In a battery pack manufacturing method described in Patent Literature 1, a laminate in which a plurality of unit cells are laminated is pressurized at a first pressure for a certain period of time, and then the laminate is restrained by a restraining member while the laminate is pressurized at a second pressure lower than the first pressure.

In a power storage module manufacturing method described in Patent Literature 2, a first pressurizing step of compressing a laminate in which a plurality of power storage cells are laminated is performed, a pressurizing force is released to align each of the cells in the laminate, then a second pressurizing step of compressing the laminate again is performed, and the laminate is restrained in a state where the pressurizing force is applied.

In a battery module manufacturing method described in Patent Literature 3, a part of battery laminates is disposed between one of end plates and an intermediate plate, and an interval between the one end plate and the intermediate plate is narrowed to compress the battery laminate disposed therebetween. Then, the remaining battery laminates are disposed between the other of the end plates and the intermediate plate.

In a battery pack manufacturing method described in Patent Literature 4, all of battery cells constituting a battery pack are divided into two sets. In each of the sets, a plurality of battery cells are laminated with separators each interposed between two adjacent battery cells, and a laminate of the battery cells and the separators is compressed.

Patent Literature 1: JP7420783B

Patent Literature 2: JP7307106B

Patent Literature 3: JP7070381B

Patent Literature 4: JP2023-116062A

### SUMMARY OF INVENTION

For example, in a battery to be mounted on an electric vehicle such as an electric automobile, the number of laminated cells tends to increase in response to a request for a large capacity and/or a high voltage of the battery. As the number of cells increases, when the laminated cells and cushioning members sandwiching the cells are compressed, the cells and the cushioning members in an intermediate portion in a laminating direction are likely to be displaced in a direction perpendicular to the laminating direction. For example, in the power storage module manufacturing method described in Patent Literature 2, the pressurizing force is released between the first pressurizing step and the second pressurizing step, and alignment of the cells in which the positional displacement occurs is performed.

An object of the present invention is to improve assemblability of a battery.

An aspect of the present invention is a method for manufacturing a battery in which a plurality of cushioning members and a plurality of cells each disposed between adjacent two of the cushioning members are laminated, the method includes compressing a laminate of the plurality of cells and the plurality of cushioning members while repeatedly pressurizing and depressurizing the laminate in a laminating direction in response to a change in posture of the laminate with respect to the laminating direction.

According to the present invention, assemblability of the battery can be improved.

### BRIEF DESCRIPTION OF DRAWINGS

FIG. 1 is a front view schematically showing an example of a battery for illustrating an embodiment of the present invention.

FIG. 2 sequentially shows an example of a method for manufacturing the battery of FIG. 1.

FIG. 3 sequentially shows an example of the method for manufacturing the battery of FIG. 1.

FIG. 4 is a flowchart of a laminate compression step in the method for manufacturing the battery in FIGS. 2 and 3.

FIG. 5 schematically shows the compression step of FIG. 4.

FIG. 6 schematically shows the compression step of FIG. 4.

FIG. 7 schematically shows the compression step of FIG. 4.

FIG. 8 shows another example of the method for manufacturing the battery of FIG. 1.

FIG. 9 is a cross-sectional view showing an example of a cushioning member of the battery of FIG. 1.

### DESCRIPTION OF EMBODIMENTS

An example of a battery and a method for manufacturing the battery, which illustrate an embodiment of the present invention will be described with reference to the accompanying drawings.

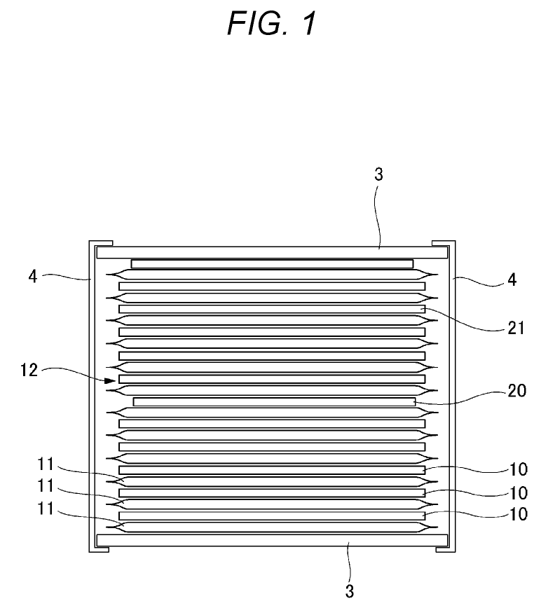

A battery 1 shown in FIG. 1 includes a plurality of cells 10 and a plurality of cushioning members 11. The cells 10 and the cushioning members 11 are flat or planar, and are laminated in a thickness direction. Each of the cells 10 is sandwiched between two adjacent cushioning members 11. The battery 1 further includes a set of end plates 3 that sandwich a laminate 12 of the plurality of cells 10 and the plurality of cushioning members 11 in a laminating direction, and frames 4 that restrain the set of end plates 3 to each other. The frames 4 fix an interval between the set of end plates 3.

Further, the battery 1 includes one or more surface pressure sensors. In an example shown in FIG. 1, the battery 1 includes two surface pressure sensors, that is, a first surface pressure sensor 20 and a second surface pressure sensor 21, the first surface pressure sensor 20 is disposed at a central portion in the laminating direction of the laminate 12, and the second surface pressure sensor 21 is provided at one end in the laminating direction of the laminate 12. The first surface pressure sensor 20 and the second surface pressure sensor 21 acquire an in-plane pressure distribution in a direction intersecting the laminating direction. The number of surface pressure sensors installed in the laminate 12 may be one or three or more. An installation location of the surface pressure sensor is not limited to one end or the central portion in the laminating direction of the laminate 12, but the surface pressure sensor is preferably installed at least in the central portion considering a positional displacement of the cells 10 and the cushioning members 11 in an intermediate portion in the laminating direction being likely to occur.

The cell 10 is a so-called laminate cell in which a positive electrode, a negative electrode, a separator, and an electrolyte are sealed in a laminate film pack. In general, as compared with a can cell in which a material of the positive electrode or the like is sealed in a cylindrical or rectangular metal container, the laminate cell is high in energy density per volume and excellent in heat dissipation.

The cell 10 may be a lithium-ion battery or a nickel-hydrogen battery using a liquid electrolyte, or may be an all-solid-state battery using a solid electrolyte. In the all-solid-state battery, the solid electrolyte also serves as the separator. In general, as compared with a lithium-ion battery or the like using a liquid electrolyte, the all-solid-state battery is excellent in temperature resistance and has a long life.

In either a cell using the liquid electrolyte or a cell using the solid electrolyte, a material having an excellent energy density but a large expansion amount, such as metallic lithium, an alloy containing metallic lithium, or silicon (Si), may be used for the negative electrode. For example, on a surface of the negative electrode made of the metallic lithium or the like, lithium is deposited due to repeated charging and discharging. When there is a variation in the in-plane pressure distribution of the cell 10, precipitation of lithium may be biased. The biased precipitation of lithium promotes the precipitated lithium to grow into a protrusion shape, which may reach the positive electrode to cause a short circuit. Therefore, it is required to uniformly pressurize each in-plane location of the cell 10 with an appropriate load.

Further, in the cell using the solid electrolyte, it is important to densify the solid electrolyte and increase adhesion between the electrodes and the solid electrolyte in order to smooth movement of ions between the electrodes. Therefore, it is required to uniformly pressurize each in-plane location of the cell 10 with an appropriate load.

The cushioning member 11 is a pouch in which a fluid such as a gas or a liquid is sealed in a bag-shaped insulating packaging material. Based on isotropy of a fluid pressure inside the cushioning member 11, a load acting on each in-plane location of the cell 10 sandwiched between two adjacent cushioning members 11 is equalized. The cushioning member 11 is not limited to a pouch as long as the cushioning member 11 has cushioning properties and pressure equalization properties.

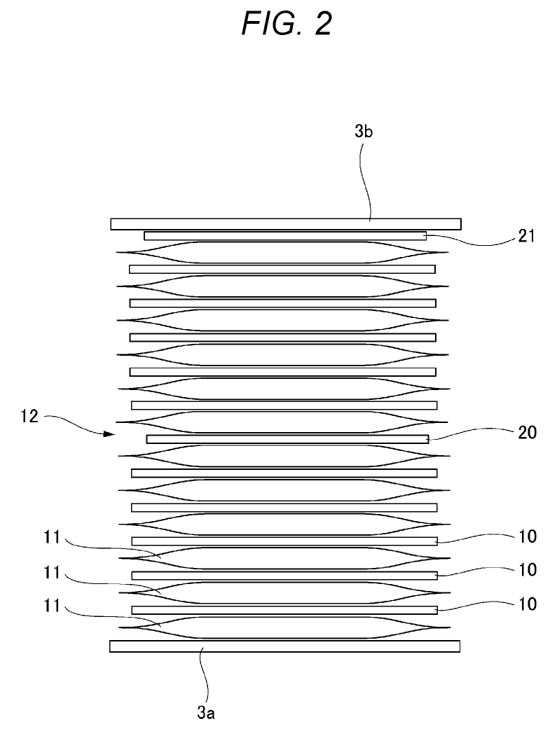

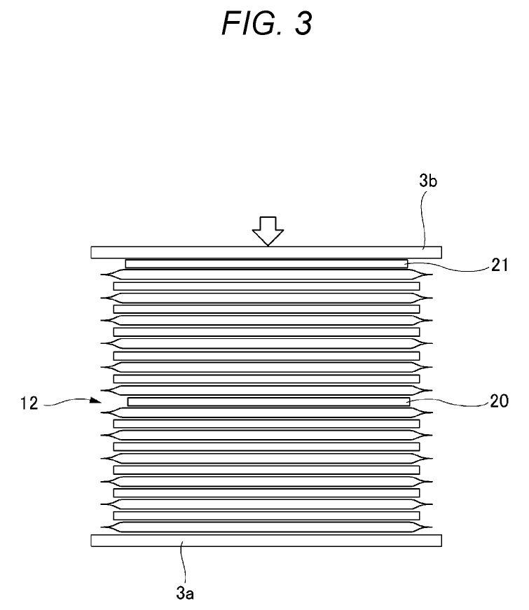

An example of a method for manufacturing the battery 1 will be described with reference to FIGS. 2 to 7. Hereinafter, the laminating direction of the cells 10 and the cushioning members 11 will be described as an upper-lower direction for convenience.

As shown in FIG. 2, the cells 10, the cushioning members 11, the first surface pressure sensor 20, and the second surface pressure sensor 21 are laminated on a lower end plate 3a supported by a compression device. The first surface pressure sensor 20 is disposed at the central portion in the laminating direction of the laminate 12. The second surface pressure sensor 21 is disposed at an upper end in the laminating direction of the laminate 12 and is adjacent to an upper end plate 3b.

A load in the upper-lower direction is applied to the upper end plate 3b, and the laminate 12 is compressed in the laminating direction. In a compression step, each of the first surface pressure sensor 20 and the second surface pressure sensor 21 acquires a pressure distribution in a horizontal plane at a corresponding installation location.

After the compression of the laminate 12 is completed, the frames 4 are assembled to the lower end plate 3a and the upper end plate 3b to form the battery 1. Then, the load applied to the upper end plate 3b is removed.

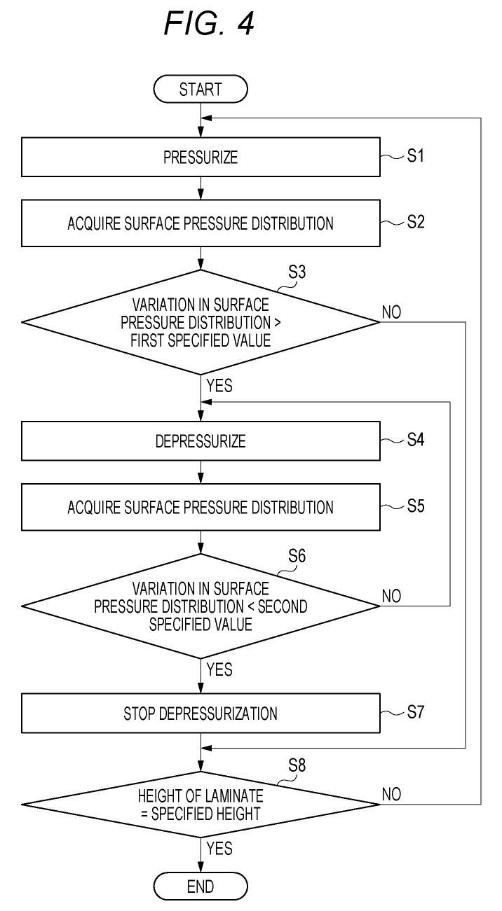

As shown in FIG. 4, in the compression step of the laminate 12, the laminate 12 is pressurized and the laminate 12 is compressed (step S1). The pressure distribution in the horizontal plane at the installation location of each sensor is acquired by a corresponding one of the first surface pressure sensor 20 and the second surface pressure sensor 21, and the pressure distribution is sequentially monitored by a control unit of the compression device (step S2).

If a variation in the surface pressure distribution at the installation location of each sensor is smaller than a first specified value (step S3: No), the compression of the laminate 12 is continued. The variation in the surface pressure distribution may be evaluated by, for example, a difference between a maximum value and a minimum value of the pressure at each in-plane location, or may be evaluated by a standard deviation of the pressure. On the other hand, if the variation in the surface pressure distribution at the installation location of at least one sensor exceeds the first specified value (step S3: Yes), the compression of the laminate 12 is interrupted, and the laminate 12 is depressurized (step S4).

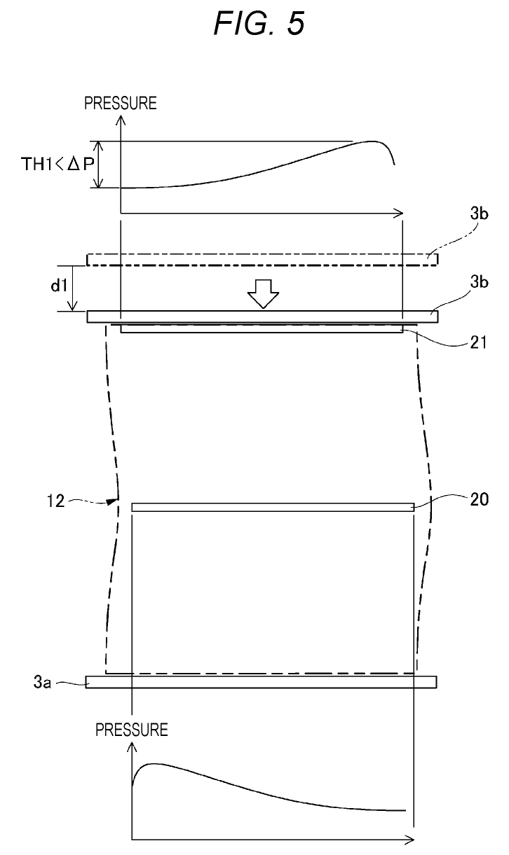

Referring to FIG. 5, assuming that the cells 10 and the cushioning members 11 in the central portion in the laminating direction of the laminate 12 are displaced toward a right direction in the figure, and a posture of the laminate 12 with respect to the laminating direction changes, in the surface pressure distribution in the central portion of the laminate 12 acquired by the first surface pressure sensor 20, a pressure on a left side relatively increases, and a pressure on the right side relatively decreases. Further, in the surface pressure distribution in the upper end of the laminate 12 acquired by the second surface pressure sensor 21, a pressure on the left side relatively decreases, and a pressure on the right side relatively increases. Based on such a change tendency of the pressure distribution, a sign of occurrence of the positional displacement of the cells 10 and the cushioning members 11 can be captured.

Therefore, the compression of the laminate 12 is interrupted at a timing when the variation in the surface pressure distribution at the installation location of at least one sensor (for example, a difference ΔP between the maximum value and the minimum value of the pressure) exceeds a first specified value TH1. Accordingly, the positional displacement of the cells 10 and the cushioning members 11 can be prevented.

In a process of interrupting the compression of the laminate 12 and depressurizing the laminate 12, the pressure distribution in the horizontal plane at the installation location of each sensor is acquired by a corresponding one of the first surface pressure sensor 20 and the second surface pressure sensor 21, and the pressure distribution is sequentially monitored by the control unit of the compression device (step S5). If the variation in the surface pressure distribution at the installation location of at least one sensor is larger than a second specified value (step S6: No), the depressurization of the laminate 12 is continued. The second specified value is set to a value smaller than the first specified value. On the other hand, if the variation in the surface pressure distribution at the installation location of each sensor is less than the second specified value (step S6: Yes), the depressurization of the laminate 12 is stopped (step S7).

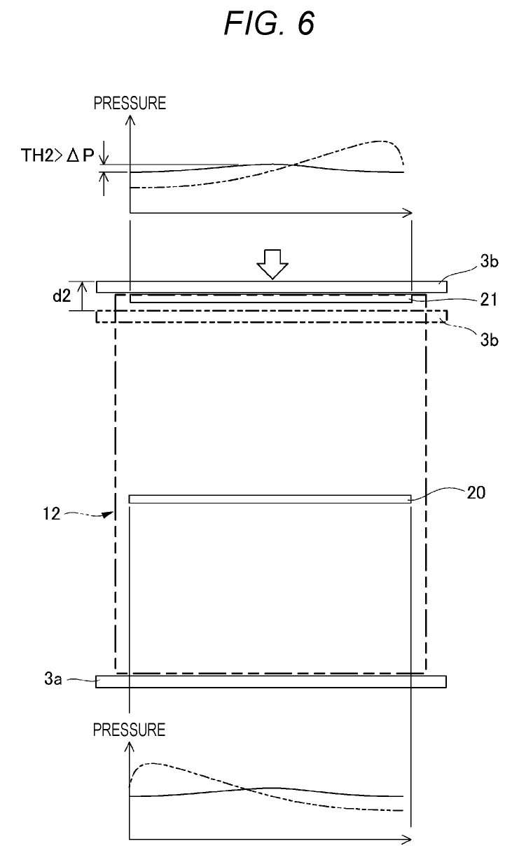

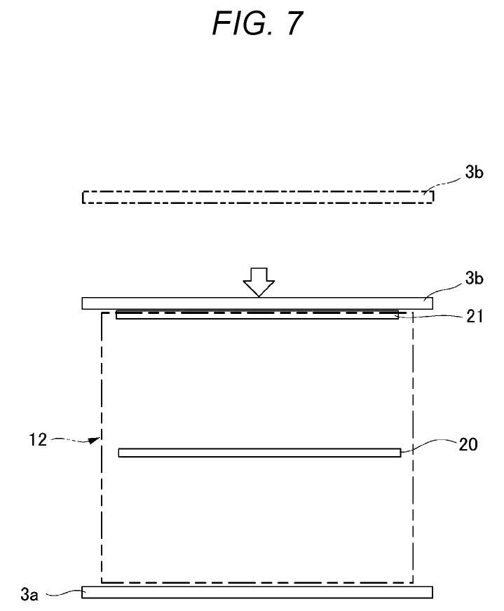

Referring to FIG. 6, as the laminate 12 is depressurized, the compressed laminate 12 is restored according to a depressurization amount. As the laminate 12 is restored, the surface pressure distribution is leveled. The depressurization of the laminate 12 is stopped at a timing when the variation in the surface pressure distribution at the installation location of each sensor (for example, the difference ΔP between the maximum value and the minimum value of the pressure) falls below a second specified value TH2. Thereafter, as shown in FIG. 7, the pressurization of the laminate 12 is resumed, and the laminate 12 is compressed.

If the pressurization and depressurization of the laminate 12 are repeated and a height of the laminate 12 reaches a specified height (step S8: Yes), the compression of the laminate 12 is completed.

According to the method for manufacturing the battery 1 described above, the sign of the occurrence of the positional displacement of the cells 10 and the cushioning members 11 is detected based on the surface pressure distribution, and when the sign of the occurrence of the positional displacement is detected, the compression of the laminate 12 is interrupted, and the surface pressure distribution is leveled by depressurizing the laminate 12. After the surface pressure distribution is leveled, the compression of the laminate 12 is resumed. Accordingly, the laminate 12 can be compressed while maintaining a state in which the cells 10 and the cushioning members 11 are aligned in the laminating direction. By maintaining the state in which the cells 10 and the cushioning members 11 are aligned in the laminating direction, the frames 4 can be easily assembled. Further, each in-plane location intersecting a thickness direction of the cell 10 can be uniformly pressed. This is useful when the cell 10 is a cell using the solid electrolyte, and is useful when the cell 10 includes a negative electrode made of the metallic lithium or the like.

In the method for manufacturing battery 1 described above, the pressurization and depressurization of the laminate 12 are switched based on the pressure distribution in a plane intersecting the laminating direction of laminate 12, but pressurization and depressurization of the laminate 12 may be switched based on a displacement amount of a movable plate of the compression device.

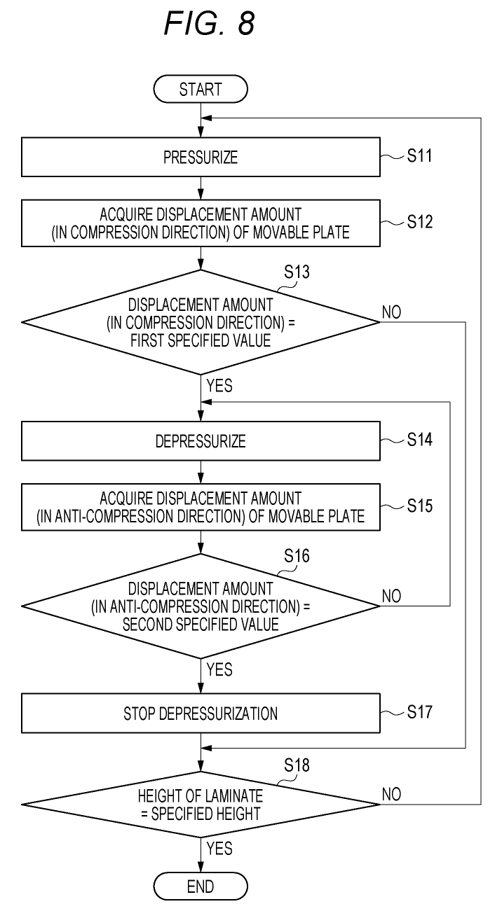

As shown in FIG. 8, the laminate 12 is pressurized and the laminate 12 is compressed (step S11). The displacement amount of the movable plate of the compression device in a compression direction is sequentially monitored by the control unit (step S12).

The compression of the laminate 12 is continued until the displacement amount of the movable plate in the compression direction reaches the first specified value (step S13: No). If the displacement amount of the movable plate in the compression direction reaches the first specified value (step S13: Yes), the compression of the laminate 12 is interrupted, and the laminate 12 is depressurized (step S14).

During the depressurization of the laminate 12, a displacement amount of the movable plate in an anti-compression direction (in other words, a decompression direction) is sequentially monitored by the control unit (step S15). The depressurization of the laminate 12 is continued until the displacement amount of the movable plate in the anti-compression direction reaches the second specified value (step S16: No). At a timing when the displacement amount of the movable plate in the anti-compression direction reaches the second specified value (step S16: Yes), the depressurization of the laminate 12 is stopped (step S17).

Thereafter, the pressurization of the laminate 12 is resumed. If the pressurization and depressurization of the laminate 12 are repeated and the height of the laminate 12 reaches the specified height (step S18: Yes), the compression of the laminate 12 is completed.

The displacement amount of the movable plate in the compression direction is a non-cumulative displacement amount based on a position of the movable plate when the pressurization of the laminate 12 is started or restarted. Further, the displacement amount of the movable plate in the anti-compression direction is a non-cumulative displacement amount based on a position of the movable plate when the depressurization of the laminate 12 is started. The first specified value for the displacement amount in the compression direction and the second specified value for the displacement amount in the anti-compression direction can be statistically set, for example, as follows.

Referring to FIGS. 5 and 6, a displacement amount d1 of the movable plate in the compression direction is acquired at a timing when the variation in the surface pressure distribution at the installation location of at least one sensor exceeds the first specified value TH1. Similarly, a displacement amount d2 of the movable plate in the anti-compression direction is acquired at a timing when the variation in the surface pressure distribution at the installation location of each sensor falls below the second specified value TH2 based on the position of the movable plate when the depressurization of the laminate 12 is started.

Through manufacturing of a plurality of batteries 1, the displacement amount d1 for each pressurization and the displacement amount d2 for each depressurization are accumulated. The first specified value for the displacement amount in the compression direction is set based on many displacement amounts d1 that are accumulated, and the second specified value for the displacement amount in the anti-compression direction is set based on many displacement amounts d2 that are accumulated.

The first specified value for the displacement amount in the compression direction set as described above can be said to be a statistical limit line in which a risk of the cells 10 and the cushioning members 11 being displaced increases. Further, the second specified value for the displacement amount in the anti-compression direction can be said to be a statistical safety line in which a risk of the positional displacement accumulated in the cells 10 and the cushioning members 11 due to the compression is reset.

By switching the pressurization and the depressurization of the laminate 12 based on the displacement amount of the movable plate of the compression device, the surface pressure sensor can be omitted, and the manufacturing of the battery 1 can be simplified.

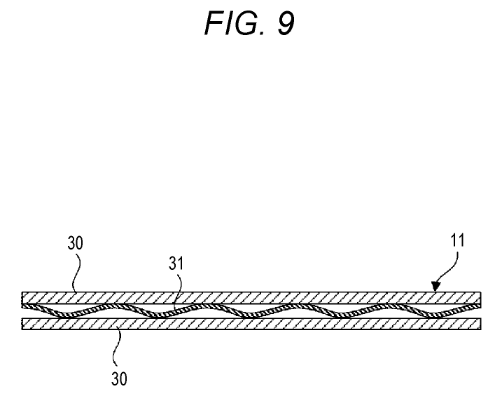

The embodiment of the present invention has been described above, but the present invention is not limited to the embodiment described above, and modifications, improvements, and the like can be made as appropriate. For example, instead of the pouch in which the fluid is sealed in the packaging material, as shown in FIG. 9, the cushioning member 11 may include a pair of foam bodies 30 as first elastic members disposed on both outer sides in the laminating direction of the laminate 12, and a wave-shaped plate spring 31 as a second elastic member disposed between the pair of foam bodies 30. The wave-shaped plate spring 31 has concave portions and convex portions alternately and continuously arranged, and these concave portions and convex portions constitute a spring structure arranged in a horizontal plane perpendicular to the laminating direction. Each of the foam bodies 30 reduces a difference in pressure between a contact portion with the plate spring 31 and a non-contact portion with the plate spring 31, and enhances uniformity of the surface pressure. A plurality of plate springs 31 may be laminated in the laminating direction, or a plurality of arc-shaped plate springs may be arranged in the horizontal plane instead of the wave-shaped plate springs 31.

In this specification, at least the following matters are described. In the parentheses, the corresponding constituent elements and the like are illustrated in the above embodiment, but the present invention is not limited thereto.

(1) A method for manufacturing a battery (battery 1) in which a plurality of cushioning members (cushioning members 11) and a plurality of cells (cells 10) each disposed between adjacent two of the cushioning members are laminated, the method including:

compressing a laminate (laminate 12) of the plurality of cells and the plurality of cushioning members while repeating pressurization and depressurization on the laminate in a laminating direction according to a change in posture of the laminate with respect to the laminating direction.

According to the method for manufacturing the battery in the above (1), the laminate can be compressed while maintaining a state in which the cells and the cushioning member are aligned in the laminating direction.

(2) The method for manufacturing the battery according to the above (1), in which

a pressure distribution in a plane in a direction intersecting the laminating direction is measured at one or more locations in the laminating direction of the laminate, and

the pressurization and the depressurization on the laminate are switched based on the pressure distribution.

According to the method for manufacturing the battery in the above (2), a sign of occurrence of a positional displacement of the cells and the cushioning members can be detected based on the surface pressure distribution.

(3) The method for manufacturing the battery according to the above (2), in which

the depressurization is performed when a variation in the pressure distribution exceeds a first specified value, and

the pressurization is performed when the variation in the pressure distribution falls below a second specified value smaller than the first specified value.

According to the method for manufacturing the battery in the above (3), the pressurization and the depressurization of the laminate can be accurately switched based on the surface pressure distribution.

(4) The method for manufacturing the battery according to the above (2), in which

the locations where the pressure distribution is measured include a central portion in the laminating direction of the laminate.

According to the method for manufacturing the battery in the above (4), the sign of the occurrence of the positional displacement of the cells and the cushioning members can be accurately detected based on the surface pressure distribution.

(5) The method of manufacturing a battery according to (1), in which

the pressurization and the depressurization on the laminate are switched based on a displacement amount of a movable plate of a compression device.

According to the method for manufacturing the battery in the above (5), the manufacturing of the battery can be simplified.

(6) The method for manufacturing the battery according to the above (5), in which

the depressurization is performed when a non-cumulative displacement amount of the movable plate in a compression direction reaches a first specified value due to the pressurization, and

the pressurization is performed when a non-cumulative displacement amount of the movable plate in an anti-compression direction reaches a second specified value smaller than the first specified value due to the depressurization.

According to the method for manufacturing the battery in the above (6), the pressurization and the depressurization of the laminate can be accurately switched based on the displacement amount of the movable plate.

(7) The method for manufacturing the battery according to any one of the above (1) to (6), in which

each of the cells includes a solid electrolyte.

(8) The method for manufacturing the battery according to any one of the above (1) to (6), in which

a negative electrode of each of the cells contains metallic lithium or an alloy containing metallic lithium.

(9) The method for manufacturing the battery according to any one of the above (1) to (6), in which

a negative electrode of each of the cells contains silicon.

(10) The method for manufacturing the battery according to any one of the above (1) to (6), in which

each of the cushioning members includes a fluid sealed in a packaging material.

(11) The method for manufacturing the battery according to any one of the above (1) to (6), in which

each of the cushioning members includes:

a pair of first elastic members (foam body 30) disposed on both sides in the laminating direction, and

a second elastic member (plate spring 31) disposed between the pair of first elastic members, and

the second elastic member has a spring structure arranged in a plane intersecting the laminating direction.

### REFERENCE SIGNS LIST

1 battery

3 end plate

4 frame

10 cell

11 cushioning member

12 laminate

20 first surface pressure sensor

21 second surface pressure sensor

What is claimed is:

1. A method for manufacturing a battery in which a plurality of cushioning members and a plurality of cells each disposed between adjacent two of the cushioning members are laminated in a laminating direction, the method comprising:
compressing a laminate of the plurality of cells and the plurality of cushioning members while repeating pressurization and depressurization on the laminate in the laminating direction according to a change in posture of the laminate with respect to the laminating direction.

2. The method for manufacturing the battery according to claim 1, wherein
a pressure distribution in a plane in a direction intersecting the laminating direction is measured at one or more locations in the laminating direction of the laminate, and
the pressurization and the depressurization on the laminate are switched based on the pressure distribution.

3. The method for manufacturing the battery according to claim 2, wherein
the depressurization is performed when a variation in the pressure distribution exceeds a first specified value, and
the pressurization is performed when the variation in the pressure distribution falls below a second specified value smaller than the first specified value.

4. The method for manufacturing the battery according to claim 2, wherein
the locations where the pressure distribution is measured include a central portion in the laminating direction of the laminate.

5. The method for manufacturing the battery according to claim 1, wherein
the pressurization and the depressurization on the laminate are switched based on a displacement amount of a movable plate of a compression device.

6. The method for manufacturing the battery according to claim 5, wherein
the depressurization is performed when a non-cumulative displacement amount of the movable plate in a compression direction reaches a first specified value due to the pressurization, and
the pressurization is performed when a non-cumulative displacement amount of the movable plate in an anti-compression direction reaches a second specified value smaller than the first specified value due to the depressurization.

7. The method for manufacturing the battery according to claim 1, wherein
each of the cells includes a solid electrolyte.

8. The method for manufacturing the battery according to claim 2, wherein
each of the cells includes a solid electrolyte.

9. The method for manufacturing the battery according to claim 3, wherein
each of the cells includes a solid electrolyte.

10. The method for manufacturing the battery according to claim 1, wherein
a negative electrode of each of the cells contains metallic lithium or an alloy containing metallic lithium.

11. The method for manufacturing the battery according to claim 2, wherein
a negative electrode of each of the cells contains metallic lithium or an alloy containing metallic lithium.

12. The method for manufacturing the battery according to claim 3, wherein
a negative electrode of each of the cells contains metallic lithium or an alloy containing metallic lithium.

13. The method for manufacturing the battery according to claim 1, wherein
a negative electrode of each of the cells includes silicon.

14. The method for manufacturing the battery according to claim 2, wherein
a negative electrode of each of the cells includes silicon.

15. The method for manufacturing the battery according to claim 3, wherein
a negative electrode of each of the cells includes silicon.

16. The method for manufacturing the battery according to claim 1, wherein
each of the cushioning members includes a fluid sealed in a packaging material.

17. The method for manufacturing the battery according to claim 2, wherein
each of the cushioning members includes a fluid sealed in a packaging material.

18. The method for manufacturing the battery according to claim 3, wherein
each of the cushioning members includes a fluid sealed in a packaging material.

19. The method for manufacturing the battery according to claim 1, wherein
each of the cushioning members includes:
a pair of first elastic members disposed on both sides in the laminating direction, and
a second elastic member disposed between the pair of first elastic members, and
the second elastic member has a spring structure arranged in a plane intersecting the laminating direction.

20. The method for manufacturing the battery according to claim 2, wherein
each of the cushioning members includes:
a pair of first elastic members disposed on both sides in the laminating direction, and
a second elastic member disposed between the pair of first elastic members, and
the second elastic member has a spring structure arranged in a plane intersecting the laminating direction.
